(19) United States
(12) Patent Application Publication
(10) Pub. No.: US 2011/0160013 A1
(43) Pub. Date: Jun. 30, 2011

(54) Rear Derailleur for Bicycle

(76) Inventor: Kristopher Wehage, Woodinville, WA (US)

(21) Appl. No.: 12/647,065

(22) Filed: Dec. 24, 2009

(51) Int. Cl. B62M 9/1242

(52) U.S. Cl. 474/80

(57) ABSTRACT

A rear derailleur is used in connection with a bicycle and is adapted to enable a chain to selectively engage with a plurality of sprocket wheels mounted to the bicycle. The rear derailleur includes an adjustment mechanism including fixed angular limits and a rotating member connected to the fixed angular limits and being rotatable relative to the fixed angular limits in a predetermined angular distance. A link member is constrained to a maximum or minimum angular limit defined by stops on the rotating member, and the angular position of the rotation member is adjusted by one user-input.

### BACKGROUND OF THE INVENTION

1. Field of the Invention

The present invention relates to a rear derailleur for a bicycle and, in particular, to a derailleur that has an improved adjustment mechanism.

2. Description of the Related Art

A rear derailleur is generally used in connection with a plurality of coaxially mounted toothed wheels, known as sprocket wheels, of a bicycle so as to provide the user of such bicycle with a selection of different gear-ratios to achieve a particular mechanical advantage during the operation of the bicycle.

Generally, the rear derailleur includes a chain guide member that is adapted to go transversely from one position to another position in response to gear-ratio changes. Also, the chain guide member includes two pulleys and the two pulleys are aligned with one of the sprocket wheels for a particular gear ratio. Further, the rear derailleur includes an adjustment mechanism, i.e. bolts and generally two bolts, which can be adjusted and one of which can be adjusted to stop the chain guide member to go transversely to a position aligned with the sprocket wheel of the largest diameter and the other of which can be adjusted to stop the chain guide member to go transversely to a position aligned with the sprocket wheel of the smallest diameter.

A problem associated with this adjustment mechanism is that there is no indication of degrees that the bolts should be adjusted. For instance, it has often happened that the bolt is adjusted to a degree the chain guide member can only go furthest to be in parallel alignment with the sprocket wheel of the second largest diameter, or to a degree that the chain guide member goes too further than an aligned position with respect to the sprocket wheel of the largest diameter. Likewise, the chain guide member may go too further than an aligned position with respect to the sprocket wheel of the smallest diameter.

The present invention is, therefore, intended to obviate or at least alleviate the problems encountered in the prior art.

### SUMMARY OF THE INVENTION

According to the present invention, a rear derailleur is used in connection with a bicycle and is adapted to enable a chain to selectively engage with a plurality of sprocket wheels mounted to the bicycle. The rear derailleur includes a first knuckle pivotally connected to the bicycle, and the first knuckle includes a protrusion. A link member is pivotally connected to the first knuckle. An adjustment mechanism is accommodated in the link member and includes fixed angular limits connected to the protrusion in a non-rotatable manner relative to the protrusion, and a rotating member which engages the fixed angular limits and being rotatable relative to the fixed angular limits in a predetermined angular distance. A second knuckle is pivotally connected to the link member. A chain guide is pivotally connected to the second knuckle and includes a derailleur pulley with which the chain of the bicycle is adapted to engage. The link member is constrained to a maximum or minimum angular limit defined by stops on the rotating member, and the angular position of the rotation member is adjusted by one user-input. The user-input includes a worm member which engages with a plurality of teeth on the rotating member. The worm gear is adjustable to cause change in the predetermined angular distance of the rotating member. Preferably, the fixed angular limits are integrally formed on the first knuckle.

In another embodiment of the present invention, the limit adjustment mechanism is located in the second knuckle. The worm member and the rotating member are installed in the link member. The fixed angular limits are connected nonrotatably to the second knuckle. Preferably, the fixed angular limits are integrally formed on the second knuckle.

In yet another embodiment of the present invention, the worm member is housed in the first knuckle. The rotating member is rotatably attached to the first knuckle. The fixed angular limits are connected nonrotatably to the link member. Preferably, the fixed angular limits are integrally formed on the link member.

In a further embodiment of the present invention, the worm member is housed in the second knuckle. The rotating member is rotatable attached to the second knuckle. The fixed angular limits are connected nonrotatably to the link member. Preferably, the fixed angular limits are integrally formed on the link member.

It is an object of the present invention that the link member is adapted to be constrained to a maximum or minimum angular limit defined by stops on the rotating member.

It is another object of the present invention that the chain guide is adapted to go transversely from an initial position to a predetermined position in response to pivot of the link member.

It is yet another object of the present invention that that the chain guide is prevented from going transversely further than an aligned position with the sprocket wheel of the largest diameter and an aligned position with the sprocket wheel of the smallest diameter.

It is a further object of the present invention that the rear derailleur has the advantage of simple construction which would be great cost and parts savings.

Other objects, advantages, and new features of the present invention will become apparent from the following detailed description of the invention when considered in conjunction with the accompanied drawings

### BRIEF DESCRIPTION OF THE DRAWINGS

FIG. 1 is a perspective view of a rear derailleur in accordance with the present invention, and the rear derailleur mounted to a bicycle on a portion of its frame, and the bicycle including a plurality of sprocket wheels with which the rear derailleur selectively cooperate.

FIG. 2 is an exploded perspective view of the rear derailleur embodying the present invention.

FIG. 3 is a cross-sectional view taken along line 3-3 of FIG. 1.

FIG. 4 is a cross-sectional view taken along line 4-4 of FIG. 1.

FIG. 5 is a cross-sectional view taken along line 5-5 of FIG. 1.

FIG. 6 is an extended cross-sectional view of FIG. 4 illustrating a chain guide of the rear derailleur transversely shifted to a position that is furthest with respect to its position in FIG. 4.

FIG. 7 is an extended cross-sectional view of FIG. 5 illustrating a chain guide of the rear derailleur transversely shifted to a position that is furthest with respect to its position in FIG. 5.

FIG. 8 is similar to FIG. 4 but illustrating the rear derailleur adjusted such that the chain guide is stopped at a different position than that shown in FIG. 4.

FIG. 9 is an extended view of FIG. 8 illustrating the chain guide of the rear derailleur shifted to a position that is furthest with respect to its position in FIG. 8.

FIG. 10 is a perspective view of a rear derailleur in accordance with a second embodiment of the present invention.

FIG. 11 is an exploded perspective view of the rear derailleur shown in FIG. 10.

FIG. 12 is a cross-sectional view of the rear derailleur taken along line 12-12 of FIG. 10.

FIG. 13 is a perspective view of a rear derailleur in accordance with a third embodiment of the present invention.

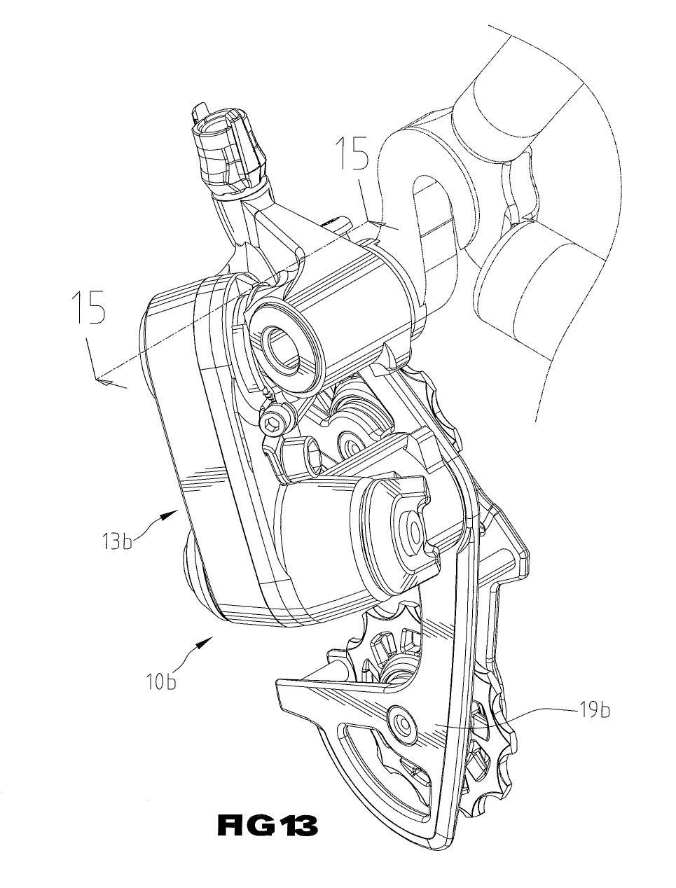

FIG. 14 is an exploded perspective view of the rear derailleur shown in FIG. 13.

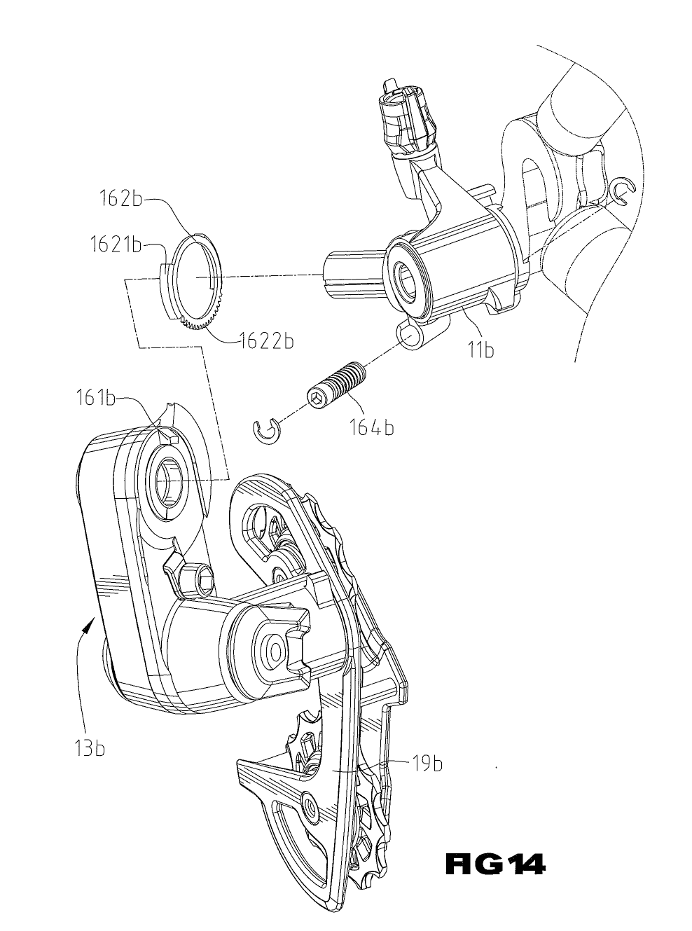

FIG. 15 is a cross-sectional view of the rear derailleur taken along line 15-15 of FIG. 13.

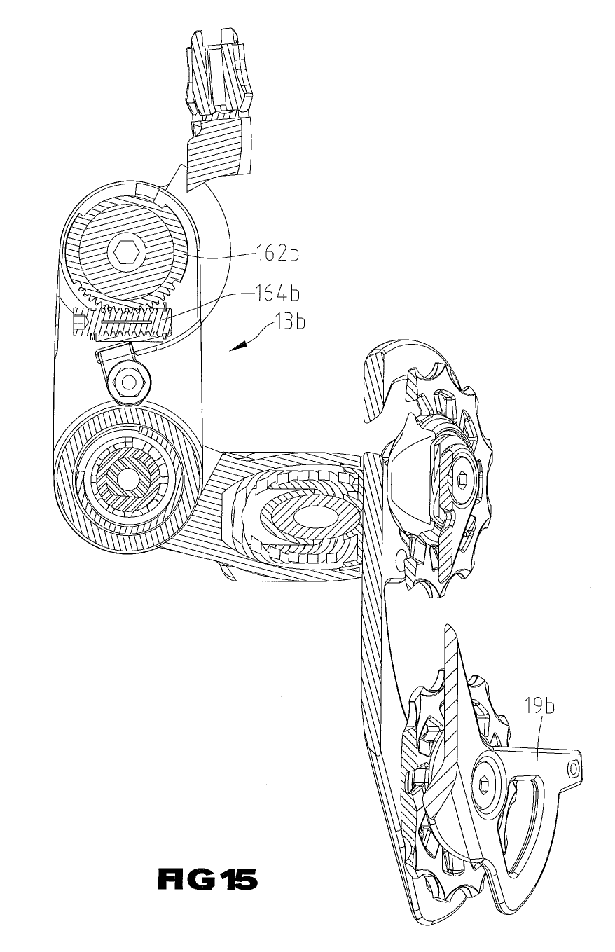

FIG. 16 is a perspective view of a rear derailleur in accordance with a fourth embodiment of the present invention.

FIG. 17 is an exploded perspective view of the rear derailleur shown in FIG. 16.

FIG. 18 is a cross-sectional view of the rear derailleur taken along line 18-18 of FIG. 15.

### DETAILED DESCRIPTION OF THE PREFERRED EMBODIMENT

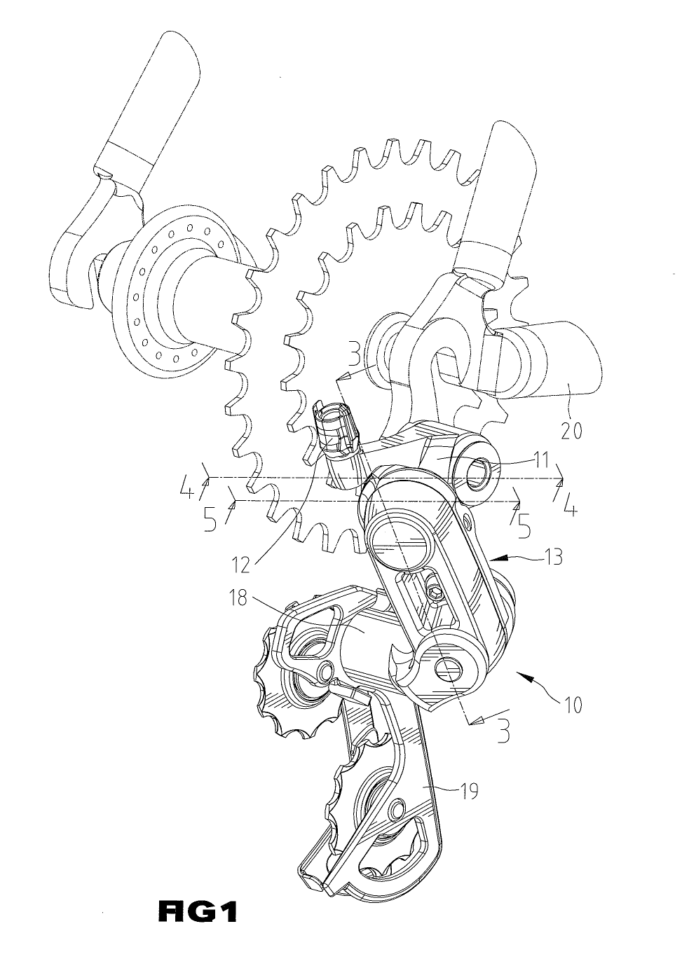

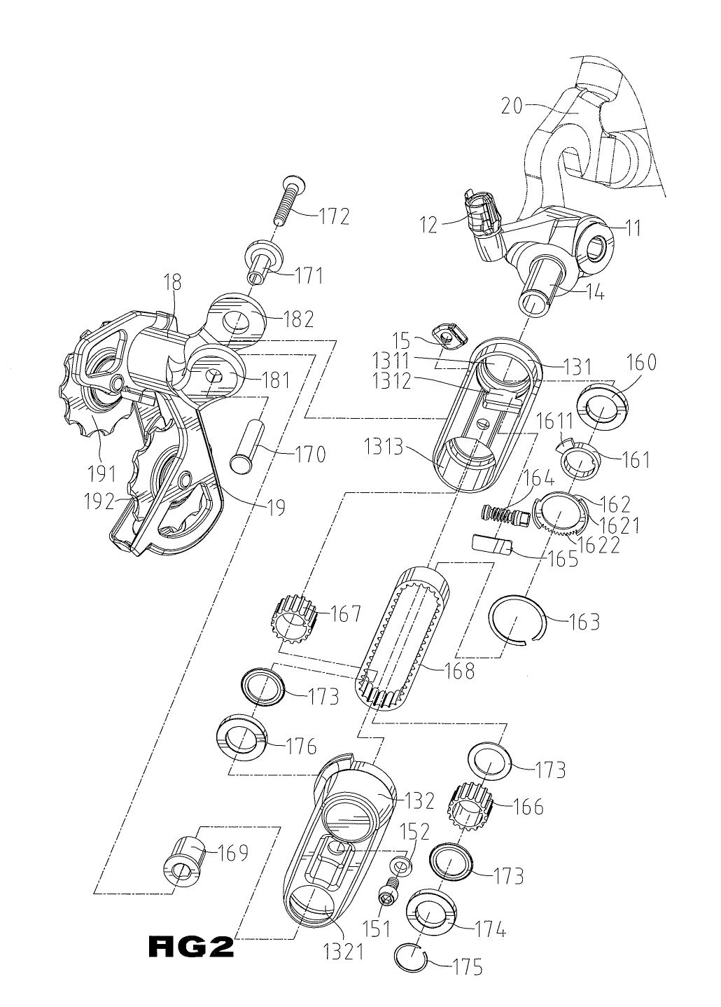

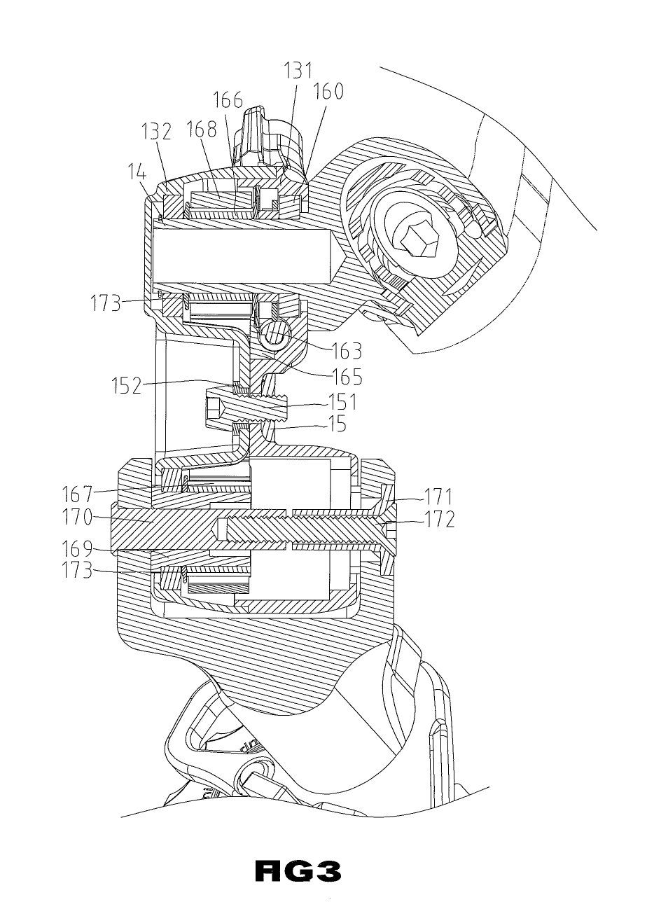

Referring to FIGS. 1 through 9, a rear derailleur 10 in accordance with the present invention is adapted to be mounted to a bicycle on a portion of its frame 20, such as a dropout of the bicycle. The rear derailleur 10 includes a first knuckle 11 pivotally mounted on the frame 20. The first knuckle 11 is operably pivotal by a user-input, for example by means of a cable. The cable is received in a barrel adjuster 12 of the first knuckle 11 and has an end terminated and retained in a link member 13. The link member 13 is pivotally connected to the first knuckle 11. Additionally, the link member 13 includes a first link cover 131 receiving a cable pinch washer 15 that is used to prevent the cable from disengaging from the link member 13 and a second link cover 132 coupling with the first link cover 131. The cable pinch washer 15 is engaged with the first link cover 131 by inserting a bolt 151 through the second link cover 132, the first link cover 131 and the cable pinch washer 15. Further, a washer 152 is used in connection with the bolt 151.

The first 131 and second 132 link covers accommodate an adjustment mechanism 16 therein. The adjustment mechanism 16 includes fixed angular limits 161 of a ring shape and being received in a first compartment 1311 of the first link cover 131. Additionally, the fixed angular limits 161 are insertably connected to the protrusion 14 and are prevented from relative rotation therebetween by a protuberance extending inward from an inner periphery of the fixed angular limits 161 engaged in a groove inset in an outer periphery of the protrusion 14. Preferably, a bearing 160 is utilized and is insertably connected to the protrusion 14 prior to installation of the fixed angular limits 161. Additionally, the first compartment 1311 is hollow and the protrusion 14 can extend through the first compartment 1311.

The adjustment mechanism 16 also includes a rotating member 162 connected to the fixed angular limits 161. The rotating member 162 is of a ring shape and includes an inner periphery disposed on an outer periphery of the fixed angular limits 161. Additionally, the rotating member 162 is received in the first compartment 1311 and is extended through by the protrusion 14. Further, a retaining ring 163 is utilized to facilitate securing of the fixed angular limits 161 and the rotating member 162 in the first compartment 1311.

The rotating member 162 is rotatable relative to the fixed angular limits 161 in a predetermined angular distance by a stop 1611 extending outward from the outer periphery of the fixed angular limits 161 selectively engaged with two oppositely disposed stops 1621 of the rotating member 162. Each stop 1621 extends radially and outward from an outer periphery of the rotating member 162. Each stop 1621 further includes an edge extending transversely to its radial extending direction. The rotating member 162 further includes a plurality of teeth 1622 disposed on the outer periphery and between the two stops 1621 for engaging with a worm member 164 which is a worm gear. The warm member 164 can be adjusted to cause changes in the predetermined angular distance of the rotating member 162. Additionally, the worm member 164 is disposed in a recess 1312 which is inset in a side of the first link cover 131 and is adjacent to and in communication with the first compartment 1311. The recess 1312 receives a worm member cover 165 for facilitating the second link cover 132 to retain the worm member 164.

The adjustment mechanism 16 further includes first 166 and second 167 timing gears, and a timing belt 168 utilized in connection with the first 166 and second 167 timing gears. The first timing gear 166 is received in a cavity of the second link cover 132 and is connected to the protrusion 14 of the first knuckle 11 in a non-rotatable manner relative to the protrusion 14 by a protuberance extending inward from an inner periphery of the first timing gear 166 engaged in a groove defined in the protrusion 14. The second timing gear 167 is disposed in a spaced relation with the first timing gear 166 and is received in another cavity of the second link cover 132. Additionally, the second timing gear 167 is connected to an axle 169 in a non-rotatable manner relative to the axle 169 by a protuberance extending inward from an inner periphery of the second timing gear 167 engaged in a slot defined in the axle 169.

The timing belt can be replaced by a 4-bar linkage, timing chain, or gear.

A pivot pin 170, a pin cap 171, and a screw 172 collectively cooperate with the axle 169 to retain the axle 169 as well as pivotally connect a second knuckle 18 to the link member 13. Specifically, the axle 169 includes a through hole defined therein and is inserted into an opening 1321 defined in the second link cover 132, and the pivot pin 170 is inserted into a first connecting section 181 of the second knuckle 18 and the through hole of the axle 169. Additionally, the pin cap 171 is inserted into a second connecting section 182 of the second knuckle 18 and a second compartment 1313 defined in the first link cover 131 and includes a through hole defined therein, and the screw 172 is inserted into the through hole of the pin cap 171 to engage with the pivot pin 170. Additionally, the second knuckle 18 is utilized for installation of a chain guide 19 which includes a top derailleur pulley 191 and a bottom derailleur pulley 192 with which a chain of the bicycle is adapted to engage.

In addition, the timing belt 168 is prevented from disengagement from the first 166 and second 167 timing gears by engaging a plurality of belt guide plates 173 on the protrusion 14 and the axle 169, respectively. Further, a bearing 174 is utilized and is insertably connected to the protrusion 14. The bearing 174 is disposed in juxtaposed to one belt guide plate 173 and is prevented from disengagement from the protrusion 14 by a retainer 175. Moreover, a bearing 176 is utilized and is insertably connected to the axle 169 and disposed in juxtaposed to one belt guide plate 173.

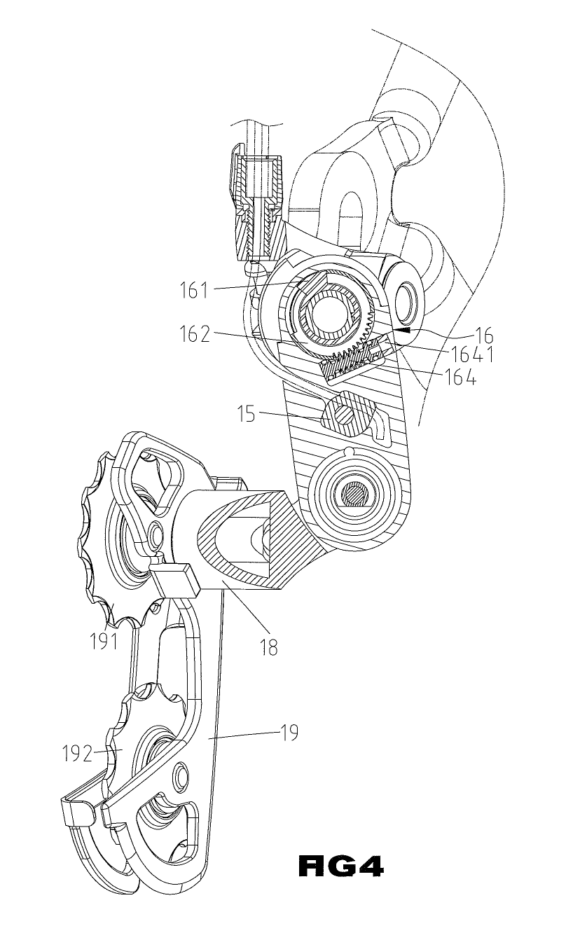

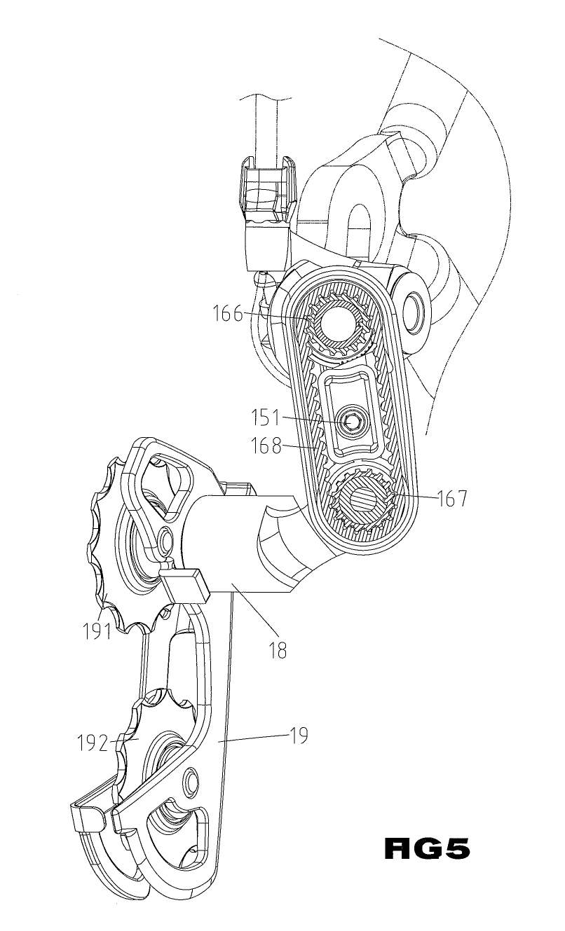

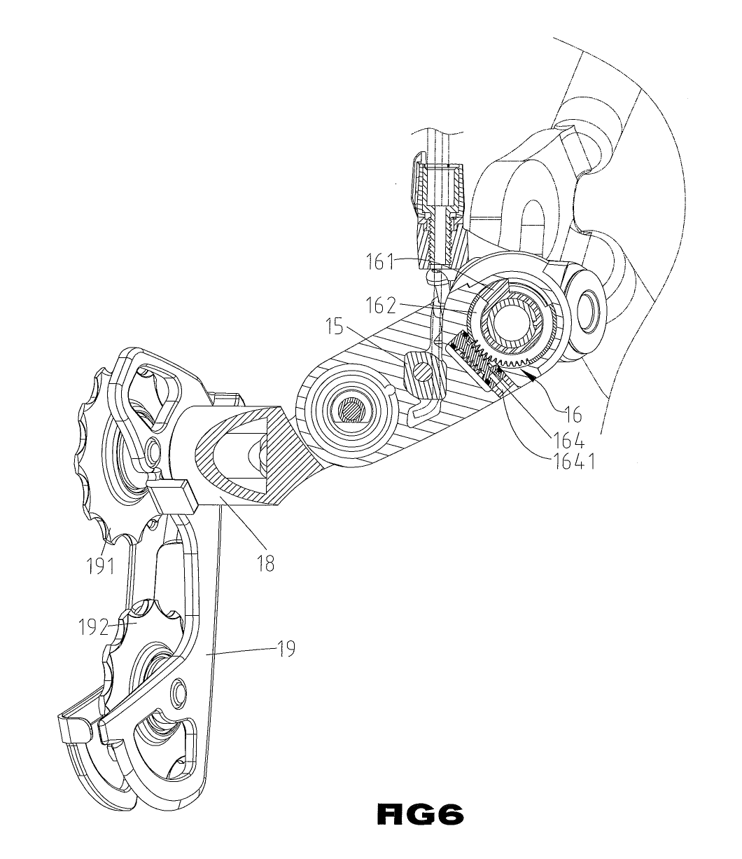

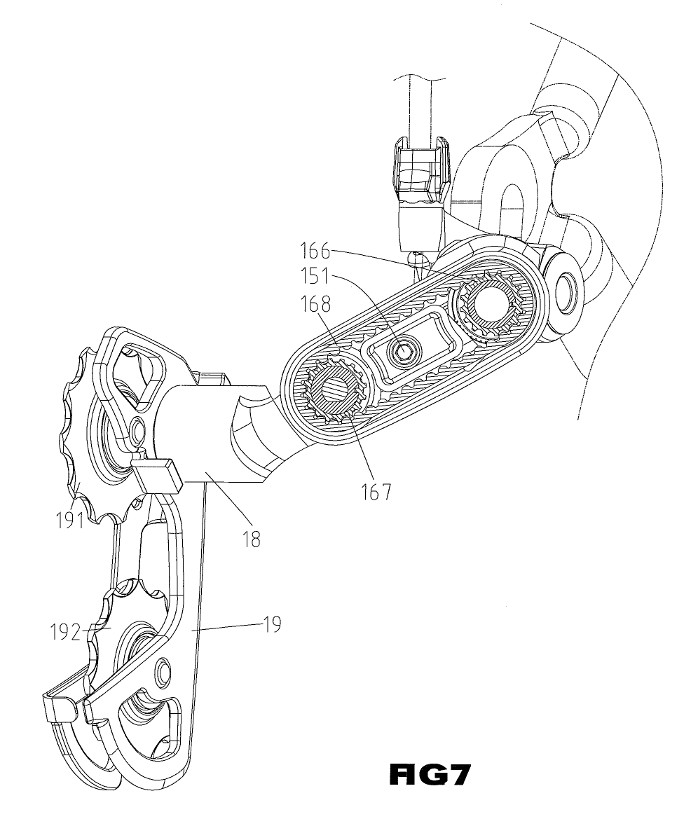

FIGS. 4 and 5 show that the chain guide 19 is at an initial position and the rotating member 162 has one stop 1621 engaging with the stop 1611 of the fixed angular limits 16; and FIGS. 6 and 7 show the link member 13 is pivoted by the cable and the rotating member 162 starts to rotate to cause the other stop 1621 move toward the stop 1611 of the fixed angular limits 16, and the rotating member 162 is prevented from further rotation as the stop 1621 is obstructed by the stop 1611. As shown in FIGS. 6 and 7, the chain guide 19 therefore goes transversely from the initial position to a predetermined position, i.e. a position in alignment with the sprocket wheel of the largest diameter.

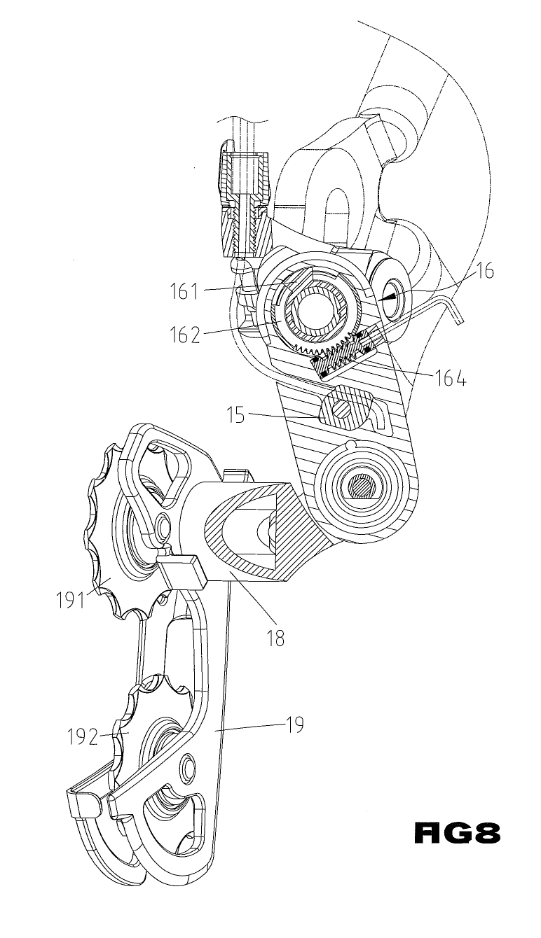

FIG. 8 shows the angular position of the rotating member 162 is adjusted by one user-input. Specifically, the worm member 164 is adjusted for setting the chain guide 19 at another initial position. A tool is adapted to engage with an adjusting section 1641 of the worm member 164 for rotation of the worm member 164.

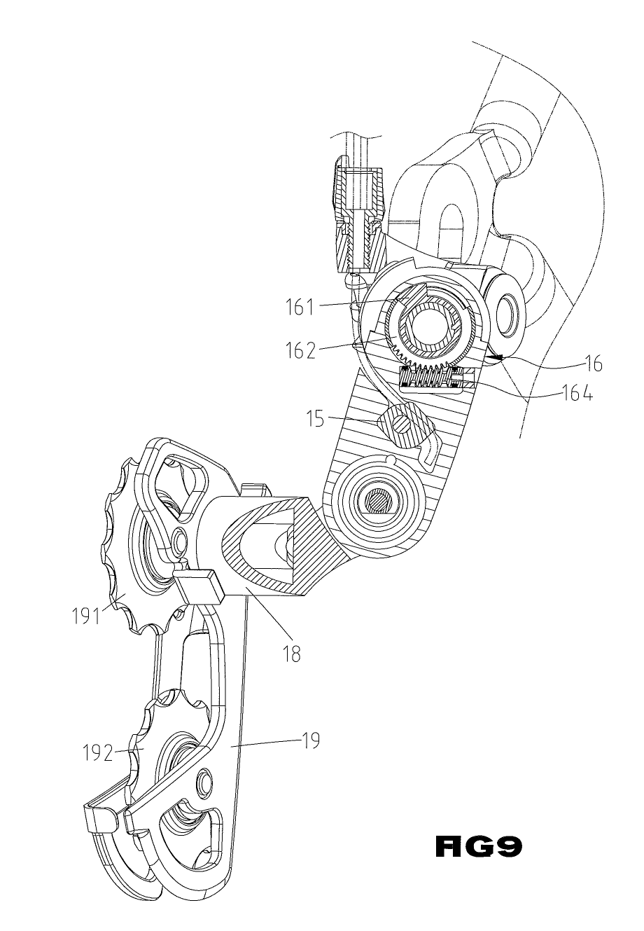

FIG. 9 shows that the cable actuates pivotal movement of the link member 13, and the chain guide 19 goes transversely from the initial position to another predetermined position.

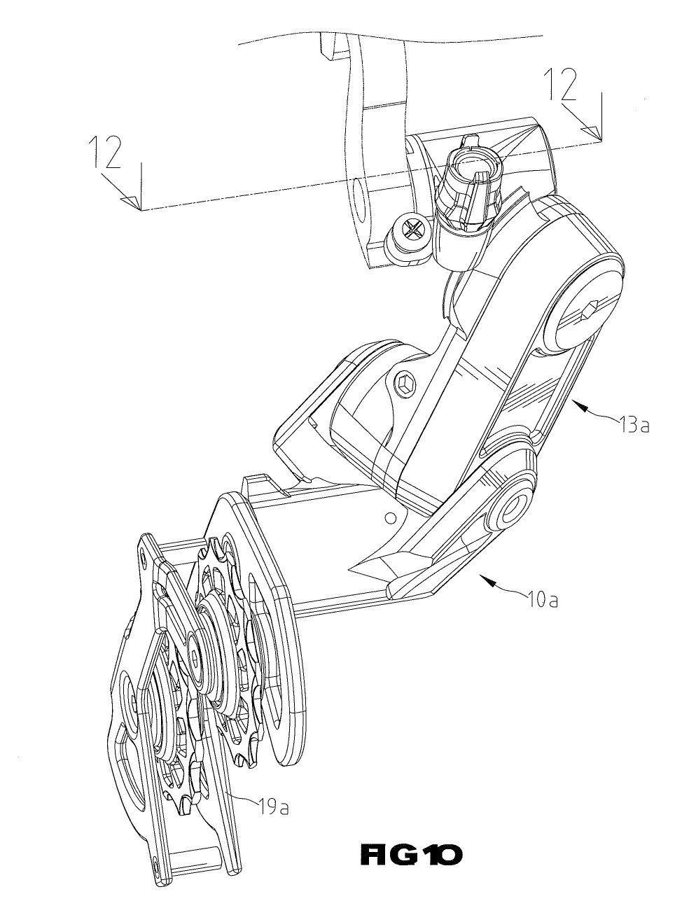

FIGS. 10 through 12 show a rear derailleur in accordance with a second embodiment of the present invention, and wherein like numerals are employed to denote like components of the first embodiment, however, bearing the suffix “a”. The second embodiment is similar to the first embodiment except that a limit adjustment mechanism 16a is located in a second knuckle 18a. A worm member 164a and a rotating member 162a are installed in the link member. Further, the limit adjustment mechanism 16a includes fixed angular limits 161a connected nonrotatably to the second knuckle 18a.

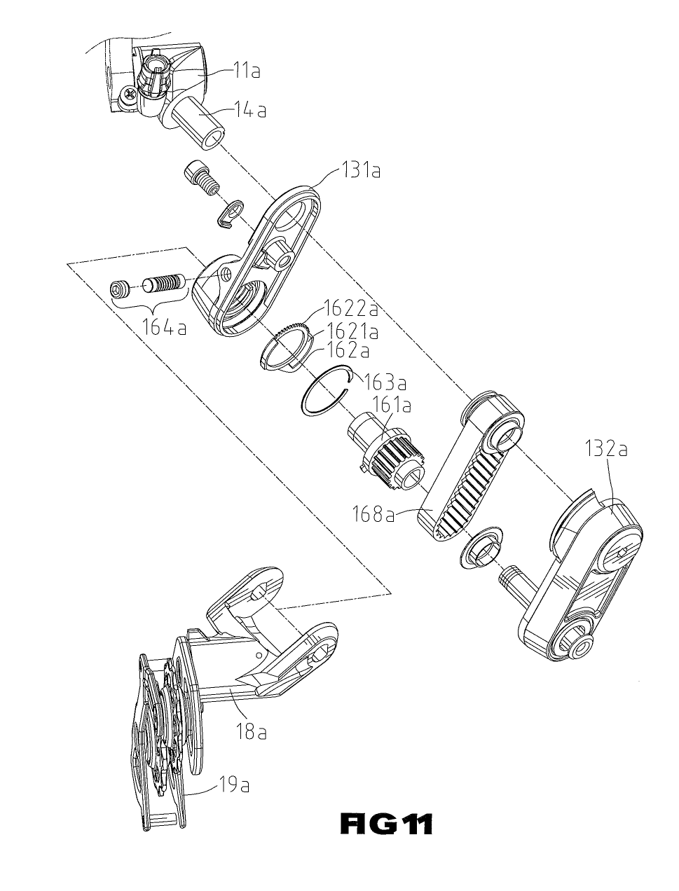

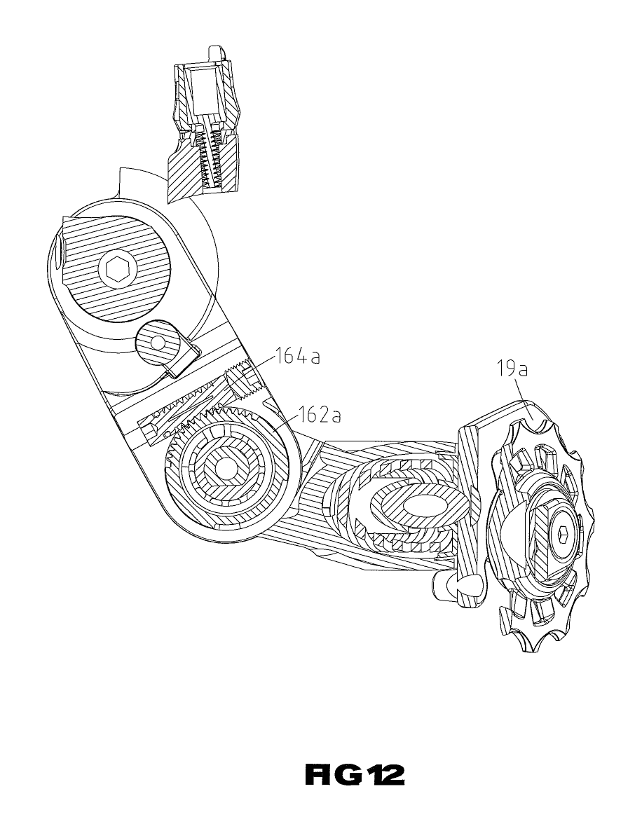

FIGS. 11 through 12 show a rear derailleur in accordance with a third embodiment of the present invention, and wherein like numerals are employed to denote like components of the first embodiment, however, bearing the suffix “b”. The third embodiment is similar to the first embodiment except that a worm member 164b is housed in a first knuckle 11b. A rotating member 162b is rotatably attached to the first knuckle 11b. Further, a limit adjustment mechanism 16b includes fixed angular limits 161b connected nonrotatably to a link member 13b.

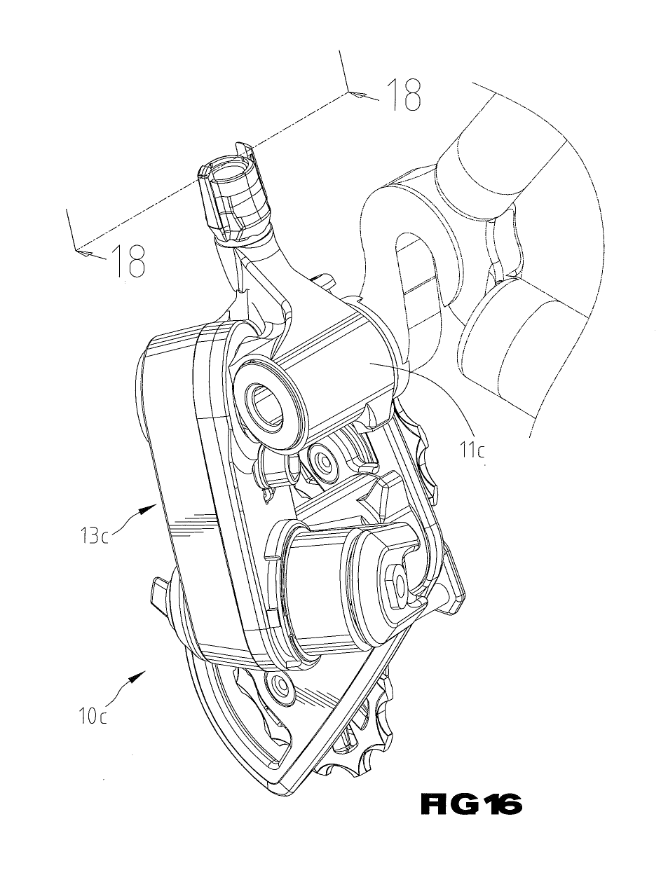

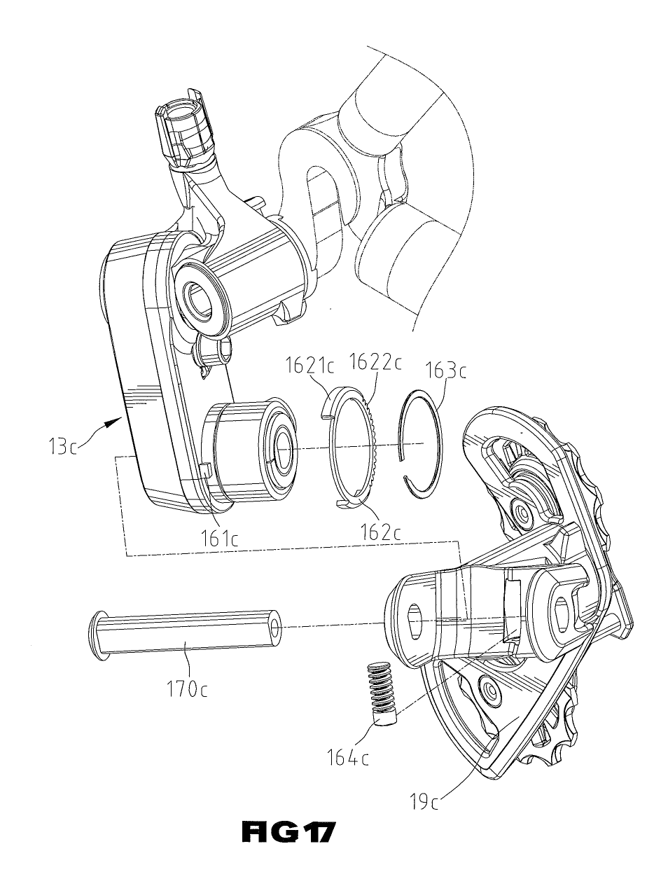

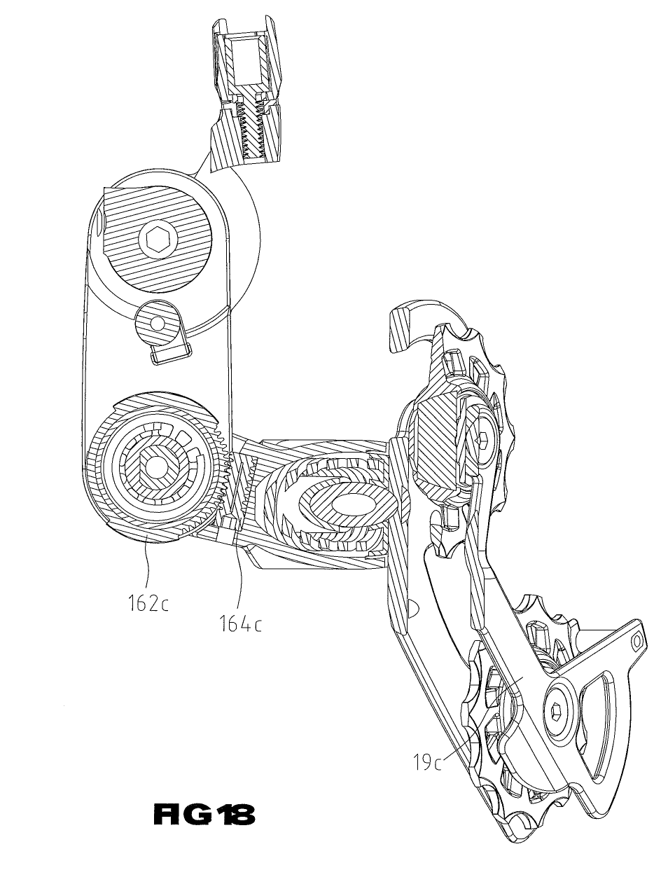

FIGS. 16 through 18 show a rear derailleur in accordance with a fourth embodiment of the present invention, and wherein like numerals are employed to denote like components of the first embodiment, however, bearing the suffix “c”. The fourth embodiment is similar to the first embodiment except that a worm member 164c is housed in a second knuckle 18c. A rotating member 162c is rotatable attached to the second knuckle 18c. Further, a limit adjustment mechanism 16c includes fixed angular limits 161c connected nonrotatably to a link member 13c.

In addition, the preferred embodiments show the limit adjustment mechanism 16, 16a, 16b, and 16c installed in a rear derailleur utilizing a timing belt and timing gears, however, it is an aspect of the present invention that the mechanism 16, 16a, 16b, and 16c can also be installed in any rear derailleur which includes a first and second knuckle connected by one or more link members, such as a 4-bar linkage parallelogram-type rear derailleur.

While the specific embodiments have been illustrated and described, numerous modifications come to mind without significantly departing from the spirit of invention, and the scope of invention is only limited by the scope of the accompanying claims.

What is claimed is:

1. A rear derailleur which enables a chain to selectively engage with a plurality of sprocket wheels and comprising:
an adjustment mechanism including fixed angular limits and a rotating member engaging the fixed angular limits and being rotatable relative to the fixed angular limits in a predetermined angular distance; and
wherein a link member is constrained to a maximum or minimum angular limit defined by stops on the rotating member, and the angular position of the rotation member is adjusted by one user-input.

2. The rear derailleur as claimed in claim 1 further comprising a chain guide pivotally connected to a second knuckle, with the chain guide including derailleur pulley with which the chain engages.

3. The rear derailleur as claimed in claim 1 further comprising a user-input consisting of a rotating worm member, which engages a plurality of teeth on the rotating member, which is a worm gear, with the worm gear being adjustable to cause changes in the predetermined angular distance of the rotating member.

4. The rear derailleur as claimed in claim 3 wherein the worm member includes an adjusting section with which a tool is adapted to engage for rotation of the worm member.

5. The rear derailleur as claimed in claim 3 wherein the rotating member includes two oppositely disposed stops selectively engaging with the fixed angular limits.
